(19) United States
(12) Patent Application Publication
(10) Pub. No.: US 2026/0361064 A1
(43) Pub. Date: Nov. 12, 2026

(54) Holder For Flexibly Holding A Double Busbar

(71) Applicant: Lisa Dräxlmaier GmbH, Vilsbiburg (DE)

(72) Inventors: Dominik Pflumm, München (DE); Wenhao Zeng, Braunschweig (DE); Robert Saller, Egglkofen (DE); Manuel Leitner, Braunau (AT)

(73) Assignee: Lisa Dräxlmaier GmbH, Vilsbiburg (DE)

(21) Appl. No.: 19/487,037

(22) PCT Filed: Apr. 29, 2024
(86) PCT No.: PCT/EP2024/061744

§ 371 Date: Nov. 24, 2025

(30) Foreign Application Priority Data
May 24, 2023 (DE) 10 2023 113 638.0

(51) Int. Cl. H02G 3/32; B60R 16/02

(52) U.S. Cl. CPC H02G 3/32; B60R 16/0215

(57) ABSTRACT

The present disclosure relates to a holder for flexibly holding a double busbar in an electric vehicle, wherein the double busbar has two electrically conductive, elongate and parallel busbars with a flat cross-section, each wrapped by an insulation and stacked flat side on flat side one on top of the other to form a busbar stack. The holder includes the following: a first component made of a flexible material, which is designed to enclose the double busbar around a longitudinal direction of the two busbars, wherein the first component has a first spring stiffness along the two flat sides of the busbar stack and has a second spring stiffness along two side surfaces of the busbar slack laterally bounding the two flat sides; and a second component which encloses the first component and has a fixing element for fixing the holder in the electric vehicle.

### CROSS REFERENCE TO RELATED APPLICATIONS

This application is a national stage entry of international application PCT/EP2024/061744, filed Apr. 29, 2024, which claims priority to German patent application 02023113638.0, filed May 24, 2023, the content of the both of which is incorporated herein by reference.

### BACKGROUND OF THE INVENTION

### Field of the Invention

The present invention relates to a bracket or mounting bracket or holder (used interchangeably herein) for flexibly holding a double conductor rail, in particular a high-voltage double conductor rail in an electric vehicle. The bracket serves to support and fix the double conductor rail and can be integrated into a traction path or also into a charging path of the electric vehicle.

### Description of Related Art

Due to relative movements between the electric drive unit and the high-voltage (HV) battery during the operation of a battery electric vehicle (BEV), the traction path must compensate for certain movements. These relative movements create stresses in the aluminum conductor that cannot be permanently absorbed by the material. In order to cope with this using a rigid conductor, specific mountings must be used to guide and dampen these movements.

### BRIEF SUMMARY OF THE INVENTION

A task of the invention is therefore to create an improved bracket that tolerates the movement in the rigid conductor and allows it to a certain extent in order to reduce stresses in the material.

The inventive solution is based on the idea of creating a bracket for a high-voltage double rail in an electric vehicle which can specifically influence the stresses in the material through the geometry and material of the bracket. The bracket presented here allows the movement of the rigid conductor to be tolerated and permitted to a certain extent, so that stresses in the material can be reduced. This limited freedom of movement is achieved in the bracket disclosed here by using a flexible material, for example TPE or LSR, with a specific geometry. The geometry and material allow specific spring stiffnesses and damping to be achieved in two spatial planes, which can thus tolerate a certain amount of movement of the high-voltage double rail.

Although this disclosure presents a bracket for high-voltage double rails (HVDS), it is understood that the bracket can also be used for other rigid conductors, such as round rigid conductors or rigid conductors with a different geometry. The bracket is particularly suitable for use with a rigid conductor, such as HVDS, in the traction path of the electric vehicle, but it can also be used in the charging path of the electric vehicle.

The bracket presented here comprises a flexible element, hereinafter also referred to as the first component made of a flexible material. The technical advantage of this flexible element is that it allows the electric motor movements of the electric vehicle to be controlled and balanced more specifically.

According to a first aspect, the above-described task is solved by a bracket for flexibly holding a double conductor rail in an electric vehicle, wherein the double conductor rail has two electrically conductive, elongated and parallel to each other, each of which is surrounded by insulation and stacked flat side to flat side to form a busbar stack, wherein the bracket comprises: a first component made of a flexible material, which is designed to enclose the double conductor rail around a longitudinal direction of the two conductor rails, wherein the first component has a first spring stiffness along the outer flat sides of the conductor rail stack and a second spring stiffness along two side surfaces of the conductor rail stack that laterally bound the outer flat sides; and a second component which surrounds the first component and has a fixing element for fixing the bracket in the electric vehicle.

The technical advantage of this bracket is that, due to the spring stiffness in both directions transverse to the longitudinal direction, it tolerates and, to a certain extent, allows movement in the double busbar in order to reduce stresses in the material.

According to an exemplary embodiment of the bracket, the first spring stiffness is designed to allow a predetermined range of movement of the double busbar in a direction along the outer flat sides of the busbar stack perpendicular to the longitudinal direction of the two busbars; and the second spring stiffness is designed to allow a predetermined range of motion of the double busbar in a direction along the two side surfaces of the busbar stack perpendicular to the longitudinal direction of the two busbars.

This offers the technical advantage of allowing a range of motion in two spatial directions perpendicular to the longitudinal direction of the double busbar. This eliminates stress in the material and prevents premature material fatigue.

According to an exemplary embodiment of the bracket, the first component has material recesses of a first geometric shape along the outer flat sides of the busbar stack, which allow the first component to be compressed and/or stretched in accordance with the first spring stiffness along the outer flat sides of the busbar stack; and the first component has material recesses of a second geometric shape along the two side surfaces of the busbar stack, which allow compression and/or elongation of the first component in accordance with the second spring stiffness along the two side surfaces of the busbar stack.

This offers the technical advantage that certain spring rigidities can be easily achieved with the material recesses. In particular, different spring rigidities can be set in the different spatial directions according to the design of the material recesses.

According to an exemplary embodiment of the bracket, the material recesses of the first geometric shape and/or the material recesses of the second geometric shape form a regular pattern.

This offers the technical advantage that the spring stiffness can be adjusted evenly over the length of the material recesses.

According to an exemplary embodiment of the bracket, the material recesses of the first geometric shape form circular and square openings, each of which is followed by a square opening; and the material recesses of the second geometric shape form square openings of different widths, which are arranged consecutively.

This offers the technical advantage that the material recesses are easy to manufacture, for example using an injection molding process.

According to an exemplary embodiment of the bracket, the first component consists of a thermoplastic elastomer (TPE) or a liquid silicone rubber (LSR).

This offers the technical advantage that TPE and LSR can be used for a wide range of applications and with various other materials due to the constantly increasing number of material types and the possibilities for bonding with different metals and plastics. For example, LSR material types with hardnesses of 20 to 70 can be used, which meet different flexibility requirements.

According to an exemplary embodiment of the bracket, the second component consists of a glass fiber-reinforced polyamide, for example PA6 GF30.

This offers the technical advantage that PA6 is versatile, for example for molded and extruded components. The plastic offers excellent toughness and wear resistance with good sliding properties and can therefore be used for components subject to heavy loads. Due to the glass fiber reinforcement, its strength properties are increased accordingly.

According to an exemplary embodiment of the bracket, the bracket with the two components consists of a two-component (2K) injection-molded component or a two-component (2K) 3D-printed component.

This offers the technical advantage that the bracket is easy to manufacture, for example using 2-component injection molding or 3D printing.

According to an exemplary embodiment of the bracket, the bracket with the two components can be opened and, when open, can be placed around the double busbar.

This offers the technical advantage that the bracket can be easily attached to and detached from the double busbar, which makes maintenance and repair easy.

According to an exemplary embodiment of the bracket, when opened, the bracket consists of two housing shells, each of which comprises part of the first component and part of the second component.

This offers the technical advantage that the two housing shells can be easily opened and closed again, which reduces the assembly effort.

According to an exemplary embodiment of the bracket, the first component also forms a film hinge with which the two housing shells can be opened. Instead of the film hinge, another type of hinge can also be formed.

This offers the technical advantage that the film hinge makes handling easier, as the upper and lower housing halves are connected to each other.

According to an exemplary embodiment of the bracket, the second component has a locking element that is designed to lock the two housing shells together when closed.

This offers the technical advantage that the bracket can be securely attached to the double busbar without the two housing halves opening unintentionally.

According to an exemplary embodiment of the bracket, the first component has a third spring stiffness along the longitudinal direction of the two busbars, which is several times greater than the first and/or second spring stiffness, wherein the third spring stiffness is designed to suppress movement of the two busbars in the longitudinal direction of the two busbars.

This offers the technical advantage that the busbars are firmly fixed in the longitudinal direction, while different degrees of movement are permitted in the two transverse directions of the busbars.

According to an exemplary embodiment of the bracket, the first component forms a central web along the two side surfaces of the busbar stack, which is adapted to a contour of the two side surfaces of the busbar stack.

This offers the technical advantage that the central web can engage in the space between the two busbars stacked on top of each other, thereby providing a firm hold by the bracket.

According to an exemplary embodiment of the bracket, the fixing element has a through-opening for screwing the bracket into the electric vehicle.

This offers the technical advantage that the bracket can be attached to the vehicle in a simple and robust manner.

According to a second aspect, the above-described task is solved by a method for manufacturing a bracket for flexibly holding a double conductor rail in an electric vehicle, wherein the double conductor rail has two electrically conductive, elongated and parallel to each other, each of which is surrounded by insulation and stacked flat side to flat side to form a busbar stack, the method comprising the following steps: injection molding a first component made of a flexible material, which is designed to enclose the double busbar around a longitudinal direction of the two busbars, wherein the first component has a first spring stiffness along the outer flat sides of the busbar stack and a second spring stiffness along two side surfaces of the busbar stack laterally bounding the outer flat sides; and injection molding a second component which encloses the first component and has a fixing element for fixing the bracket in the electric vehicle.

The technical advantage of such a method is that a bracket as described above can be produced in a simple manner. A bracket can be produced which, due to the spring stiffnesses in both directions transverse to the longitudinal direction, tolerates and allows a certain degree of movement in the double busbar in order to reduce stresses in the material.

According to an exemplary embodiment of the method, the bracket can be manufactured using a 2K injection molding process as a two-component (2K) injection molded component.

With this method, a bracket according to the first aspect described above can be easily manufactured as a 2K injection molded part.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

Further advantages and details of the invention are explained in more detail by way of example with reference to the embodiments shown in the schematic figures, wherein:

FIG. 1 depicts a 3D representation of a bracket 100 according to the invention with an inserted double busbar 110;

FIG. 2 depicts a 3D representation of the mounting bracket 100 according to the invention in the open state;

FIG. 3 depicts a side view of the mounting bracket 100 according to the invention in the closed state;

FIG. 4a depicts a 3D representation of the first component 120 of the bracket 100 made of flexible material in the closed state;

FIG. 4b depicts a 3D representation of the first component 120 of the bracket 100 made of flexible material in the unfolded state; and

FIG. 5 depicts a 3D representation of a complete assembly 500 of the bracket 100 with double busbar 110 on a carrier 501 in the vehicle.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

The figures are merely schematic representations and serve only to explain the invention. Identical or similarly functioning elements are designated with the same reference numerals throughout.

The following detailed description refers to the accompanying drawings, which form part of this document and illustrate specific embodiments in which the invention can be implemented. It is understood that other embodiments may be used and structural or logical changes may be made without departing from the concept of the present invention. The following detailed description should therefore not be understood in a limiting sense. Furthermore, it is understood that the features of the various embodiments described herein may be combined with each other, unless specifically stated otherwise.

The aspects and embodiments are described with reference to the drawings, wherein the same reference numerals generally refer to the same elements. In the following description, numerous specific details are set forth for purposes of explanation, in order to convey a thorough understanding of one or more aspects of the invention. However, it may be obvious to a person skilled in the art that one or more aspects or embodiments may be carried out with a lesser degree of specific detail. In other cases, known structures and elements are shown in schematic form to facilitate the description of one or more aspects or embodiments. It is understood that other embodiments may be used and structural or logical changes may be made without departing from the concept of the present invention.

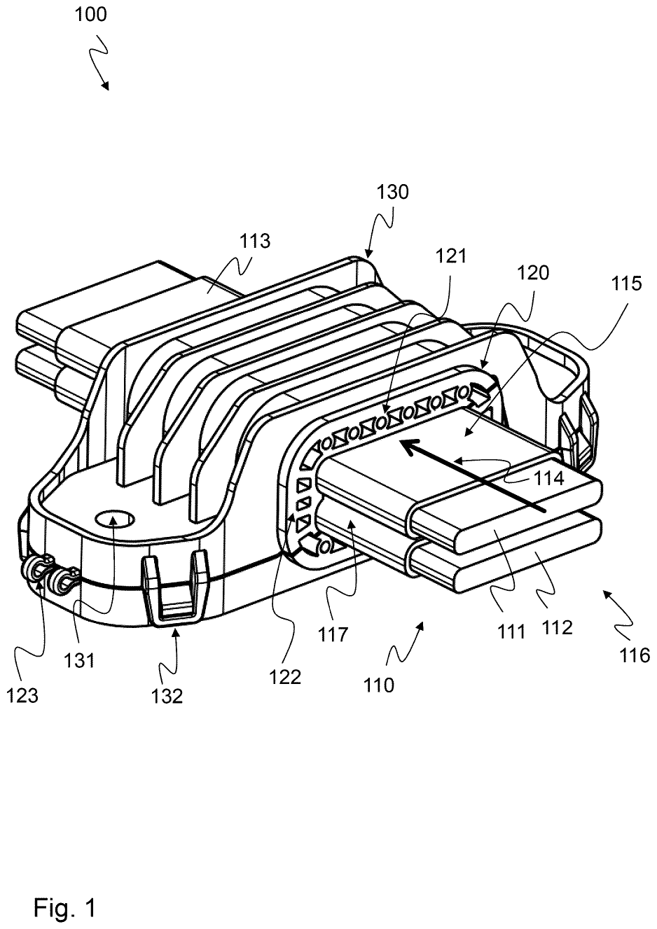

FIG. 1 shows a 3D representation of a mounting bracket 100 according to the invention with an inserted double busbar 110.

Such a bracket 100 is used to flexibly hold a double busbar 110, as shown in FIG. 1, in an electric vehicle. Such a double busbar 110 has two electrically conductive, elongated busbars 111, 112 with a flat cross-section, which run parallel to each other, are each encased in insulation 113, and are stacked flat side 115 on flat side 115 to form a busbar stack 116. The busbar stack 116 then has two outer flat sides 115, as can be seen in FIG. 1, and two side surfaces 117 delimiting the outer flat sides 115 laterally, relative to which the two busbars 111, 112 are stacked. The two inner flat sides 115 of the busbars 111, 112 are no longer visible in the busbar stack 116. The elongated and parallel busbars 111, 112 extend along a longitudinal direction 114, as shown in FIG. 1. This longitudinal direction 114 corresponds to the direction of current flow or the opposite direction of current flow through the double busbar 110.

The bracket 100 comprises a first component 120 made of a flexible material. The first component 120 is designed to enclose the double busbar 110 around the longitudinal direction 114 of the two busbars 111, 112, i.e., transversely to the longitudinal direction 114 or radially to the longitudinal direction 114. The first component 120 has a first spring stiffness along the outer flat sides 115 of the busbar stack 116, which run transversely or perpendicularly to the longitudinal direction 114, and along two side surfaces 117 of the busbar stack 116, which also run transversely or perpendicularly to the longitudinal direction 114 and delimit the outer flat sides 115 laterally, a second spring stiffness.

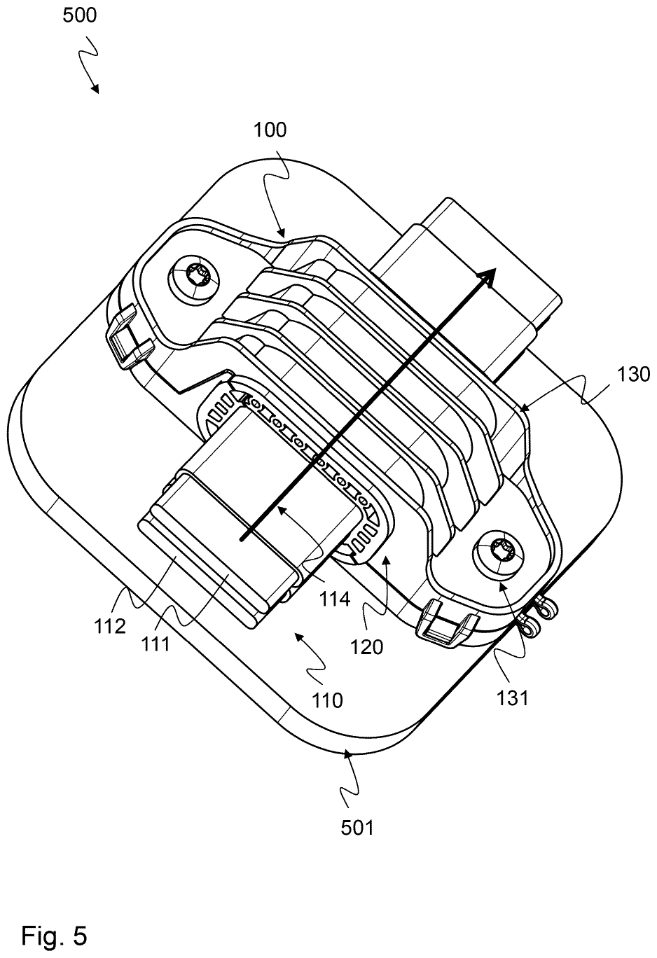

The bracket 100 comprises a second component 130, which surrounds the first component 120 and has a fixing element 131 for fixing the bracket 100 in the electric vehicle or to a carrier 501 in the vehicle, as shown in FIG. 5.

The first spring stiffness can be designed to allow a predetermined range of motion of the double busbar 110 in a direction along the outer flat sides 115 of the busbar stack 116 perpendicular to the longitudinal direction 114 of the two busbars 111, 112.

The second spring stiffness can be designed to allow a predetermined range of motion of the double busbar 110 in one direction along the two side surfaces 117 of the busbar stack 116 perpendicular to the longitudinal direction 114 of the two busbars 111, 112.

The two spring rigidities are different in one embodiment, but in another embodiment they may also be the same.

The first component 120 has material recesses of a first geometric shape 121 along the outer flat sides 115 of the busbar stack 116, which allow the first component 120 to be compressed and/or stretched along the outer flat sides 115 of the busbar stack 116 in accordance with the first spring stiffness.

The first component 120 also has material recesses of a second geometric shape 122 along both side surfaces 117 of the busbar stack 116, which allow the first component 120 to be compressed and/or stretched along both side surfaces 117 of the busbar stack 116 in accordance with the second spring stiffness.

The material recesses of the first geometric shape 121 and the second geometric shape 122 are located within an outer contour of the first component, for example between an inner contour and the outer contour of the first component, i.e., enclosed by the flexible material of the first component 120, whereby the inner contour does not necessarily have to be present. As shown here in FIG. 1, they can be located centrally between the inner contour and the outer contour of the first component 120. The material recesses can be through holes through the flexible material of the first component 120 or blind holes that are located on one side of the first component 120 and do not extend through to the other side.

In the embodiment shown in FIG. 1, the two geometric shapes 121, 122 are different, but they may also be identical.

As can be seen in FIG. 1, the material recesses of the first geometric shape 121 and the material recesses of the second geometric shape 122 can each form a regular pattern. In another embodiment, however, the material recesses of the first and/or second geometric shape can also have a random distribution.

The material recesses of the first geometric shape 121 can form circular and square openings, as shown in FIG. 1, with each circular opening followed by a square opening.

The material recesses of the second geometric shape 122 can form square openings of varying widths, as shown in FIG. 1, which are arranged consecutively.

The first component 120 may consist of a thermoplastic elastomer (TPE) or a liquid silicone rubber (LSR). The flexible material would then be TPE or LSR. Other types of elastomers, silicones, or rubber are also feasible.

The second component 130 may consist of a polyamide, for example a glass fiber-reinforced polyamide such as PA6 GF30.

The bracket 100 with the two components 120, 130 can consist of a two-component (2K) injection-molded part. This can be a single part that can be manufactured using the 2K injection molding process.

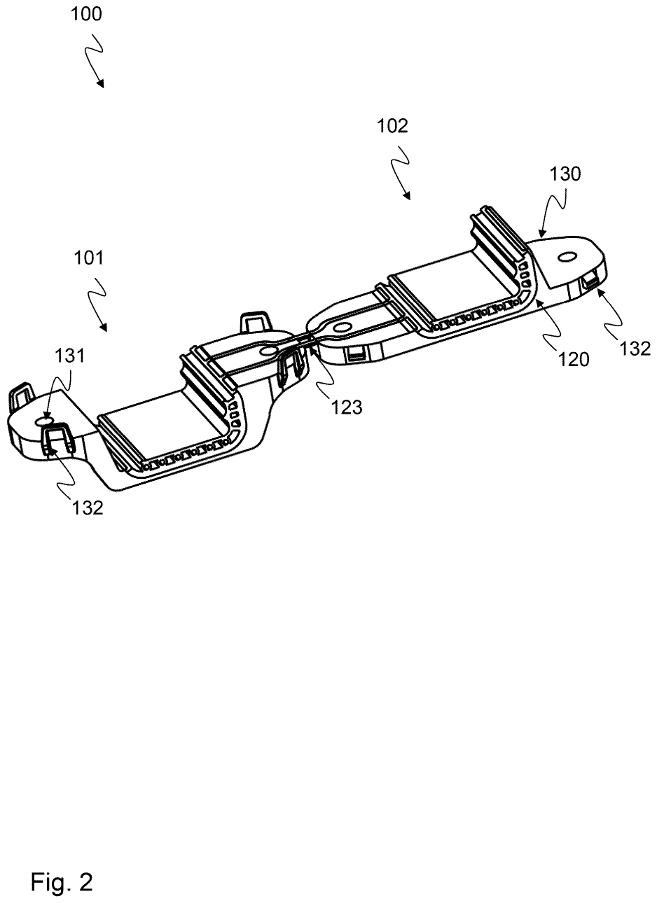

The bracket 100 with the two components 120, 130 can be designed to be hinged, as shown in FIG. 2. When hinged open, it can be placed around the double busbar 110. This allows for easy installation in the vehicle. However, a non-hinged design is also possible, in which the bracket is attached to the double busbar during its manufacture, for example by sliding the double busbar into it.

When unfolded, the bracket 100 consists of two housing shells 101, 102, as shown in more detail in FIG. 2, each of which comprises part of the first component 120 and part of the second component 130.

A non-hinged design is also possible, in which the two housing shells 101, 102 are not hinged together but can be assembled on both sides, for example, using fastening elements. For example, a snap-in connection or a screw connection can be used to connect the two housing shells 101, 102 to each other.

In the embodiment shown in FIG. 1, the first component 120 also forms a film hinge 123, which can be used to open the two housing shells 101, 102. Instead of a film hinge, another type of hinge can also be used.

The bracket 100 is placed around the high-voltage double rail 110 for mounting and locked together as shown in FIG. 1. The film hinge 123 makes handling easier because the upper and lower shells 101, 102 are connected.

The second component 120 may have a locking element 132, as shown in FIG. 1, which is designed to lock the two housing shells 101, 102 together when closed. The locking element 132 can also be used without a hinge, for example when the two housing shells 101, 102 are placed on top of each other and their assembled position is secured by the locking element 132.

The first component 120 can have a third spring stiffness along the longitudinal direction 114 of the two busbars 111, 112, which can be greater, in particular several times greater, than the first and/or second spring stiffness.

The third spring stiffness can be designed to suppress or impede movement of the two busbars 111, 112 in the longitudinal direction 114 of the two busbars 111, 112.

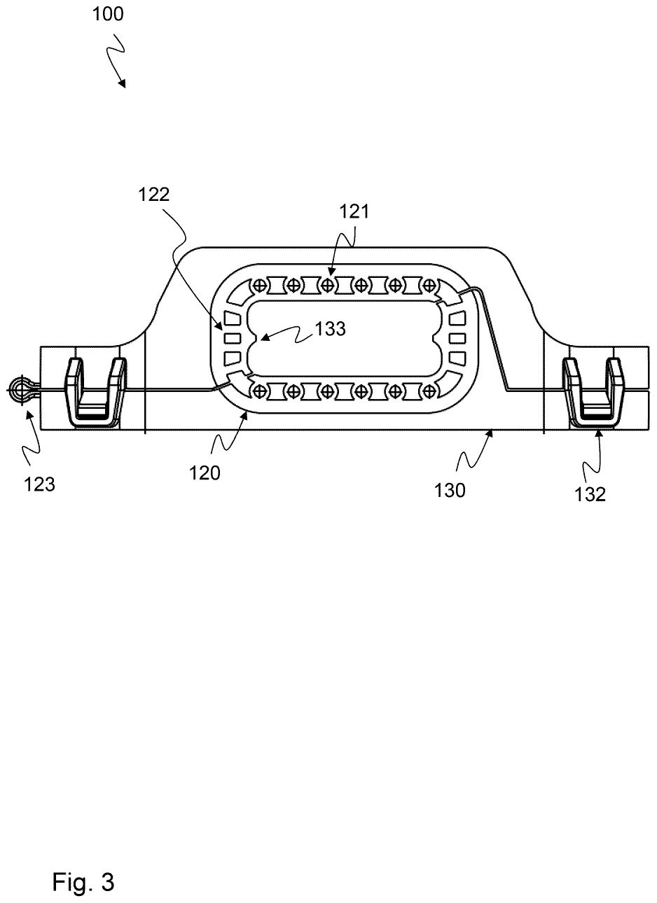

The first component 120 can form a central web 133 along the two side surfaces 117 of the busbar stack 116, as can be seen more clearly in FIG. 3, which is adapted to a contour of the two side surfaces 117 of the busbar stack 116. The central web 133 can engage in the lateral recess of the busbar stack 116, which results from stacking two laterally rounded flat busbars 111, 112 on top of each other, as shown in FIG. 1.

The fixing element 131 may have a through opening or borehole for screwing the bracket 100 into the electric vehicle. Other types of fastenings are also possible, for example a clip fastening or a plug-in fastening.

FIG. 2 shows a 3D representation of the bracket 100 according to the invention in the unfolded state.

The bracket 100 with the two components 120, 130 can be designed to be unfolded, as shown in FIG. 2, which shows the unfolded state. In this unfolded state, the bracket 100 can be placed around the double busbar 110. This allows for easy installation in the vehicle.

When unfolded, the bracket 100 consists of two housing shells 101, 102, each of which comprises part of the first component 120 and part of the second component 130.

FIG. 2 shows two housing shells 101, 102 that can be opened along the outer flat sides 115 of the busbar stack 116. In another embodiment, the two housing shells 101, 102 can also be opened along a direction perpendicular to the outer flat sides 115 of the busbar stack 116.

The bracket can consist of a 2K plastic injection molded component (TPE/LSR and PA6 GF30) that connects the upper and lower shells 101, 102 by means of a TPU/LSR film hinge 123, as shown in FIG. 2.

The film hinge 123 can thus be made of flexible material. The entire bracket 100, as shown in FIG. 2 in the open state, can be manufactured as a single component in 2-component injection molding, wherein the first component 120 represents the first component of the 2K injection molding and the second component 130 represents the second component of the 2K injection molding.

FIG. 3 shows a side view of the bracket 100 according to the invention in the closed state.

In the closed state, the two components 120, 130 of the bracket 100 can be seen, as can the material recesses of the first geometric shape 121 and the second geometric shape 122 on the flexible material of the first component 120.

The material recesses of the first geometric shape 121 and the second geometric shape 122 are located within an outer contour of the first component, for example between an inner contour and the outer contour of the first component, i.e., enclosed by the flexible material of the first component 120, whereby the inner contour does not necessarily have to be present. As shown in FIG. 3, they can be formed approximately in the middle between the inner contour and the outer contour of the first component 120. They can be formed as through holes or as blind holes.

In the embodiment shown in FIG. 3, the two geometric shapes 121, 122 are different. They each have a regular pattern. The material recesses of the first geometric shape 121 can form circular and square openings, with each circular opening followed by a square opening. The square openings can have two parallel edges and two rounded edges, with the rounded edges being adjacent to the circular openings.

The material recesses of the second geometric shape 122 can form square openings of varying widths, each of which is arranged consecutively. Thus, two squares forming a parallelogram can enclose a rectangle in the center of the side surface.

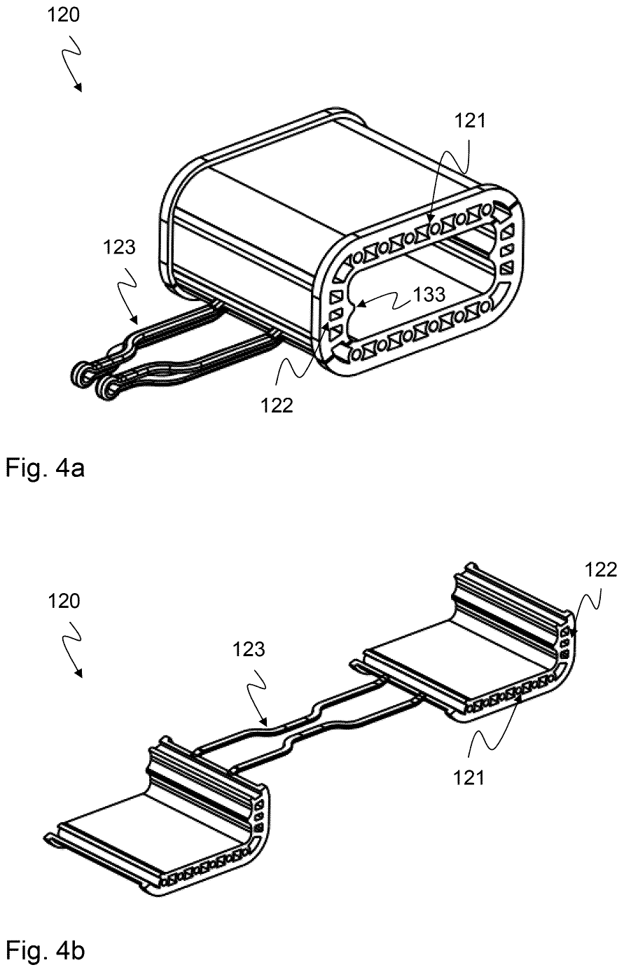

FIG. 4a shows a 3D representation of the first component 120 of the bracket 100 made of flexible material in the closed state.

In the closed state, the material recesses of the first geometric shape 121 and the second geometric shape 122 can be seen on the flexible material of the first component 120.

The film hinge 123, which can be used to open and close the bracket 100, is also shown.

The first component 120 forms a flexible element, for example made of TPE/LSR material, with a specific geometry in order to adjust stiffnesses in different axes.

Depending on the selected pattern of the material recesses of the first geometric shape 121 and the second geometric shape 122, corresponding spring rigidities are set.

FIG. 4b shows a 3D representation of the first component 120 of the bracket 100 made of flexible material in the unfolded state.

When unfolded, the material recesses of the first geometric shape 121 and the second geometric shape 122 can be seen on the flexible material of the first component 120.

The film hinge 123, which can be used to open and close the bracket 100, is also shown. It consists of the flexible material of the first component 120. The film hinge 123 can be designed as two thin webs which flexibly connect the two housing halves 101, 102 to each other.

FIG. 5 shows a 3D representation of a complete assembly 500 of the bracket 100 with double busbar 110 on a carrier 501 in the vehicle.

The bracket 100 is fastened around the double busbar 110 and mounted on a support 501 in the vehicle. Screw fasteners can be used for fastening. The fixing element 131 can be a metal bushing hole with a screw to fix the bracket to the support. The insert bushing for the screw connection can be overmolded to prevent the screw connection from settling or creeping.

The disclosure also relates to a method for manufacturing a bracket as described above in FIGS. 1 to 5. Such a method comprises the following steps:

Injection molding a first component from a flexible material, which is designed to enclose the double busbar around a longitudinal direction of the two busbars, wherein the first component has a first spring stiffness along the outer flat sides of the busbar stack and has a second spring stiffness along two side surfaces of the busbar stack laterally bounding the outer flat sides.

Injection molding a second component that surrounds the first component and has a fixing element for fixing the bracket in the electric vehicle.

The bracket can, for example, be manufactured using a 2K injection molding process as a two-component (2K) injection molded component.

The process allows the bracket 100, as described above, to be easily manufactured as a 2K injection molded part.

It should also be noted that “comprehensive” does not include any other elements or steps. and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

What is claimed is:

1. A mounting bracket configured to flexibly hold a double conductor rail in an electric vehicle, wherein the double conductor rail comprises two electrically conductive, elongated conductor rails running parallel to each other, each of which is encased in insulation and comprises a flat side on another flat side of a busbar stack with a flat cross-section, which are connected to each other by means of a connecting element and are held in a flexible manner by means of a spring element in a bracket with a flat cross-section, which spring element is connected to the bracket such that the bracket is enabled to flexibly move relative to the double conductor rail with a flat cross-section, each of which is encased in insulation and stacked flat side to flat side on top of each other to form a busbar stack, the mounting bracket comprising:
a first component comprising a flexible material enclosing the double busbar around a longitudinal direction of the two busbars, wherein the first component comprises a first spring stiffness along two side surfaces of the busbar stack that laterally delimit the outer flat sides and comprises a second spring stiffness along two side surfaces of the busbar stack that laterally delimit the inner flat sides of the busbar stack, and wherein the first spring stiffness is greater than the second spring stiffness of the busbar stack and a second spring stiffness along two side surfaces of the busbar stack that laterally bound the outer flat sides; and
a second component surrounding the first component and a fixing element configured to fix the bracket in the electric vehicle.

2. The mounting bracket according to claim 1, wherein:
the first spring stiffness is configured to enable a predetermined range of motion of the double busbar in a direction along the outer flat sides of the busbar stack perpendicular to the longitudinal direction of the two busbars; and
the second spring stiffness is configured to enable a predetermined range of motion of the double busbar in a direction along the two side surfaces of the busbar stack perpendicular to the longitudinal direction of the two busbars.

3. The mounting bracket according to claim 1, wherein:
the first component comprises material recesses of a first geometric shape arranged along the outer flat sides of the busbar stack comprising material recesses of the first geometric shape configured to enable compression and/or stretching of the first component in accordance with the first spring stiffness along the outer flat sides of the busbar stack; and
the first component comprises material recesses of a second geometric shape along both side surfaces of the busbar stack.

4. The mounting bracket according to claim 3, wherein the material recesses of the first geometric shape and/or the material recesses of the second geometric shape form a regular pattern.

5. The mounting bracket according to claim 3, wherein:
the material recesses of the first geometric shape form circular and quadrangular openings, each circular opening being followed by a quadrangular opening; and
the material recesses of the second geometric shape form quadrangular openings of different widths, each of which is arranged in succession.

6. The mounting bracket according to claim 1, wherein the first component comprises thermoplastic elastomer or liquid silicone rubber.

7. The mounting bracket according to claim 1, wherein the second component comprises glass fiber reinforced polyamide.

8. The mounting bracket according to claim 1, wherein the mounting bracket with the two components comprises a two-component injection-molded component.

9. The mounting bracket according to claim 1, wherein the bracket with the two components is configured to be opened and, in the opened state, configured to be placed around the double busbar.

10. The mounting bracket according to claim 9, wherein the bracket in an unfolded state comprises two housing shells, each of which comprises a part of the first component and a part of the second component.

11. The mounting bracket according to claim 10, wherein the first component is further configured to form a film hinge with which the two housing shells can be opened.

12. The mounting bracket according to claim 10, wherein the second component further comprises a locking element configured to lock the two housing shells together in the closed state.

13. The mounting bracket according to claim 1, wherein the first component comprises a third spring stiffness along the longitudinal direction of the two busbars comprising a third spring stiffness that is several times greater than the first and/or second spring stiffness, wherein the third spring stiffness is configured to suppress movement of the two busbars in the longitudinal direction of the two busbars.

14. The mounting bracket according to claim 1, wherein the first component comprises a central web arranged along the two side surfaces of the busbar stack, the central web adapted to a contour of the two side surfaces of the busbar stack.

15. The mounting bracket according to claim 1, wherein the fixing element comprises a through-opening configured to enable screwing of the mounting bracket into the electric vehicle.
